(19) United States
(12) Patent Application Publication
(10) Pub. No.: US 2005/0192788 A1
(43) Pub. Date: Sep. 1, 2005

(54) Simulating processor performance states

(76) Inventor: Louis B. Hobson, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/789,117

(22) Filed: Feb. 27, 2004

(51) Int. Cl. G06F 9/45

(52) U.S. Cl. 703/22

(57) ABSTRACT

Systems, methodologies, media, and other embodiments associated with simulating a processor performance state in a processor by manipulating an ACPI throttling register are described. One exemplary system embodiment includes a data structure populated with bit pattern data and register address data. The example system may also include a logic for handling a request to produce a processor performance state in a processor and for simulating the processor performance state by causing the processor to be throttled by writing a bit pattern to the ACPI throttling register.

### BACKGROUND

Desktop processors continue to draw increasing amounts of power, producing increasing amounts of heat to be dissipated by sophisticated thermal control solutions. Similarly, laptop processors continue to place increasing demands on batteries, requiring sophisticated power management solutions. Numerous patents and patent applications address various aspects of thermal and/or power management. For example, U.S. Pat. No. 6,112,164 addresses computer system thermal management using thermal windows. U.S. patent application 2004/0003301 describes controlling processor performance to regulate heat generation and U.S. patent application 2003/0177405 describes a bidirectional interface to facilitate monitoring and/or controlling temperature in a system that includes a processor. Similarly, U.S. patent application 2003/0217296 addresses adaptive central processing unit (CPU) power management based on CPU cycle tracking while U.S. patent application 2002/0194509 concerns adaptively throttling a computer based on prior CPU utilization. These patents and patent applications share a common theme of reacting to a condition by driving a processor into a processor performance state. The state may be produced, at least in part, by throttling a processor.

One example for changing processor performance by throttling a clock signal available to a processor is described in U.S. Pat. No. 6,535,798 where a STOPCLK# signal is asserted in response to detecting a thermal condition. The STOPCLK# line is itself described in U.S. Pat. No. 5,560,001, issued Sep. 24, 1996. Another example for changing processor performance is described in U.S. Pat. No. 6,272,642, wherein internal structures (e.g., registers) in a processor designed for mobile computing platforms are manipulated. Yet another example for changing processor performance is described in U.S. patent application 2003/0120960, wherein a system management interrupt (SMI) timer approach is used to emulate processor throttling. Clearly there are numerous reactive approaches to thermal and/or power management. Some of these reactive approaches employ ACPI techniques.

The Advanced Configuration and Power Interface (ACPI) standard was produced in part to address challenges associated with thermal and power management. The ACPI specification facilitates standardizing how an operating system can monitor system usage and/or temperature and then react to various conditions by changing a processor performance state. A processor performance state may specify a frequency and/or a voltage at which a processor is to operate. The processor may include an internal machine specific register (MSR) that can be programmed to control the frequency and/or voltage associated with a processor performance state. Control codes that may be written to an MSR and that facilitate establishing a desired processor performance state (e.g., frequency/voltage combination) may be stored in an ACPI table and be reported to, altered by, and/or employed by an operating system using ACPI methods.

Conventionally, processor performance states have been available to laptop processors that include MSRs dedicated to thermal and/or power management tasks, but have not been available to desktop systems with no such MSRs. Typically, the processor performance states are produced by writing MSRs to change frequency and voltage in response to a detected thermal condition.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example system for simulating a processor performance state.

FIG. 2 illustrates another example system for simulating a processor performance state.

FIG. 3 illustrates various signals associated with simulating a processor performance state.

FIG. 4 illustrates an example method for simulating a processor performance state.

FIG. 5 illustrates another example method for simulating a processor performance state.

FIG. 6 illustrates an example computing environment in which example systems and methods illustrated herein can operate.

FIG. 7 illustrates an example image forming device in which example systems and methods illustrated herein can operate.

FIG. 8 illustrates an example application programming interface (API).

### DETAILED DESCRIPTION

Implementing a true processor performance state may include changing an internal clock frequency for a processor, changing a voltage at which a processor will operate and so on. Simulating a processor performance state may include using an ACPI accessible throttling register to throttle a processor. Throttling a processor may include, for example, controlling the percentage of time during which a processor clock operates and/or controlling the percentage of time during which a processor is supplied with a clock signal. In a true processor performance state, a clock frequency may change. In a simulated processor performance state, the clock frequency for the processor may remain substantially the same but the throttling register may partially and/or completely disable the clock and/or block the clock signal from being supplied to a processor thus controlling the number of clock edges seen by a processor. This facilitates simulating the frequency change associated with a true processor performance state. Thus, the frequency change is achieved without using a machine specific register internal to a processor as is typical in true processor performance state systems.

Generally, an ACPI throttling register facilitates controlling a signal like a processor stop clock signal (STOPCLK). In one example, a STOPCLK signal can be asserted on a STOPCLK# line running into a processor (e.g., Pentium) to stop a clock signal from being supplied to the processor from about 12.5% of the time to about 87.5% of the time in steps of about 12.5%. This facilitates simulating eight processor performance states associated with eight processor frequencies. While eight frequencies and steps of 12.5% are described, it is to be appreciated that other steps and sets of frequencies may be employed. For example, an example system may simulate two processor performance states, four processor performance states, five processor performance states, and so on.

In one example, simulating a processor performance state can be facilitated by interacting with a system BIOS (Basic Input Output System). The BIOS may, through ACPI, virtualize a mechanism used by an operating system to select a processor clock frequency. While simulating a processor performance state may not include changing a processor clock frequency, data stored in the BIOS in, for example, an ACPI table, may facilitate taking a request for a processor frequency change and crafting a control signal to an ACPI throttling register. Thus, by accessing the system BIOS, the throttling registers may be supplied with information that facilitates simulating a processor performance state. The simulation may be transparent to the operating system. For example, the operating system may think that it has caused a processor performance state change while in reality the example systems and methods described herein have not produced a true processor performance state change but have instead throttled a clock signal to the processor to simulate a processor performance state change.

Simulating processor performance states facilitates having an operating system be proactive concerning thermal issues, power management, and/or other issues rather than being reactive as in a standard ACPI configuration. With simulated processor performance state, an operating system associated with a processor that does not have true processor performance state available may determine a desired processor performance state for the processor based, for example, on system demand (e.g., instructions per second required), interact with an ACPI BIOS table, locate an ACPI throttling register configured to influence the clocking of the processor, and send a bit pattern found in the ACPI BIOS table to the ACPI throttling register to influence clocking and thus simulate the desired processor performance state. While voltage may not be influenced as in a true processor performance state, the number of clock edges encountered in a time period may be changed. Thus, by simulating processor performance state, desktop systems may enjoy operating system supported adaptive power management features typically reserved for laptop systems.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend, for example, on requirements of a desired application, the environment in which it runs, the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

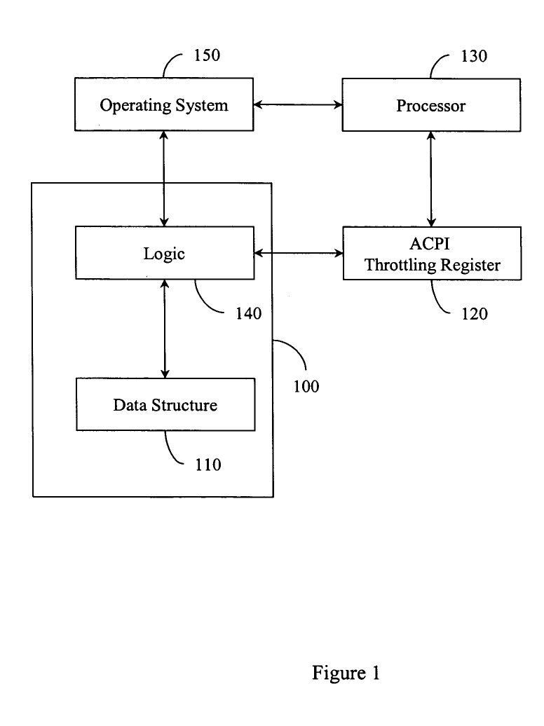

FIG. 1 illustrates an example system 100 for simulating a processor performance state. The system 100 may include, a data structure 110 stored in a memory. The data structure 110 may store the address(es) of an ACPI throttling register(s) 120 and a set of bit patterns that may be written to the ACPI throttling register 120. In one example, the data structure may also store the address(es) of an ACPI status register(s) (not illustrated) from which a value related to a throttling status established by the ACPI throttling register 120 can be read. A bit pattern may be retrieved from the data structure 110 and written to the ACPI throttling register 120. Writing the bit pattern to the throttling register 120 can cause a processor 130 to be throttled by, for example, disabling a clock signal. To determine whether the desired throttling has been implemented, a value may be read from the status register.

The system 100 may also include a logic 140 configured to receive requests from an operating system 150. The request may concern, for example, establishing a desired processor performance state in the processor 130. The system 100 may facilitate simulating a processor performance state for the processor 130 and thus may receive the request from the operating system 150 and select a bit pattern from the set of bit patterns stored in the data structure 110. The bit pattern may be written to the ACPI throttling register 120, which in turn causes the processor 130 to be throttled in a manner that simulates the desired processor performance state. Thus, the operating system 150 may think that it is establishing a desired processor performance state in the processor 130 by making a request to the logic 140. However, the logic 140 may analyze the request, determine a suitable simulated processor performance state, and select a bit pattern to write to the throttling register 120 based on the request.

In one example, the data structure 110 is stored in a memory that is operably connectable to a Basic Input Output System (BIOS) configured to facilitate controlling a function(s) performed by the processor 130. In another example, the data structure 110 may be an ACPI table stored in a memory that is operably connectable to a BIOS. In yet another example, the data structure 110 may be an ACPI table stored in a BIOS (e.g., a ROM BIOS).

The data structure 110 may store a set of bit patterns and the logic 140 may be configured to select a bit pattern from the data structure based on a request from the operating system 150. By way of illustration, the operating system 150 may be configured to request that the processor 130 be switched between a lower performance state and a higher performance state. By way of further illustration, the operating system 150 may be configured to request that the processor 130 be switched between eight processor performance states. Thus the set of bit patterns may facilitate simulating processor performance states including, but not limited to, two processor performance states that correspond to a higher performance state and a lower performance state, four processor performance states, eight processor performance states, and so on that correspond to varying degrees of processor performance. In one example, the eight processor performance states are simulated by throttling the processor 0%, 12.5%, 25%, 37.5%, 50%, 62.5%, 75%, and 87.5% of the time. While 0%, 12.5%, and so on are described, it is to be appreciated that other throttling time percentages may be employed. Similarly, a user-defined number of processor performance states may be simulated.

The ACPI throttling register 120 may be configured to cause the processor 130 to be throttled by asserting a signal on a line connected to the processor 130. For example, a STOPCLK# line may be available to the processor 130. Thus, writing a bit pattern to the throttling register 120 may cause a signal to be asserted for various amounts of time on the STOPCLK# line causing the processor 130 to effectively operate at a lower frequency while actually maintaining its internal clock frequency.

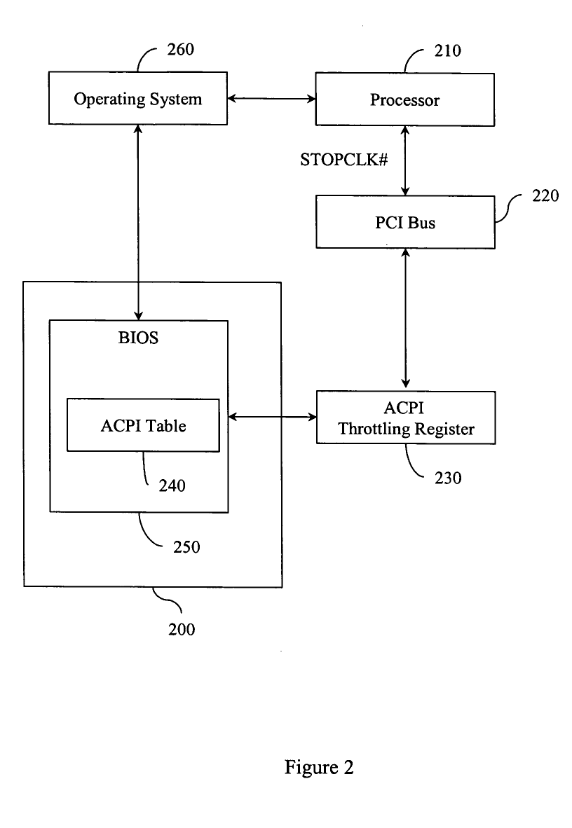

FIG. 2 illustrates another example system 200 for simulating a processor performance state on a processor 210. The processor 210 may be operably connected to a bus 220. The bus 220 may be a system bus like a PCI bus. The processor 210 may have a STOPCLK# line available to it. Thus, an ACPI throttling register 230 may be configurable to control (e.g., cause a signal to (de)asserted) the STOPCLK# line. One way to configure the ACPI throttling register 230 may be to write a bit pattern to it. The bit pattern may be retrieved from an ACPI table 240 stored in a BIOS 250 (e.g., ROM BIOS). Which bit pattern is written to the throttling register 230 may be determined by the BIOS 250 and/or other ACPI logic (not illustrated) configured to simulate a processor performance state. The BIOS 250 and/or the ACPI logic may receive a request from an operating system 260 to produce a desired processor performance state in processor 210. However, the processor 210 may not include internal machine specific registers, variable voltage supplies, variable frequency clocks and so on. Thus, rather than producing an actual processor performance state in the processor 210, the system 200 may produce a simulated processor performance state by configuring the throttling register 230 to cause the processor 210 to be throttled. The processor 210 may be throttled, for example, when a signal is asserted on the STOPCLK# line.

Thus, in one example, the system 200 may provide means for accessing ACPI data like bit patterns and throttling register addresses. These means may be, for example, various data structures stored in various computer-readable memories and/or computer-readable mediums. The system 200 may also provide means for receiving a request to drive a processor into a processor performance state. The means may be, for example, a BIOS and/or a logic configured to receive the request and select a bit pattern(s) that will cause a throttling register to cause a processor to be throttled. The system 200 may therefore also include means (e.g., software, hardware, firmware) for controlling a clock signal available to a processor by writing data retrieved from the ACPI data to an ACPI throttling register, where controlling the clock signal simulates the processor performance state.

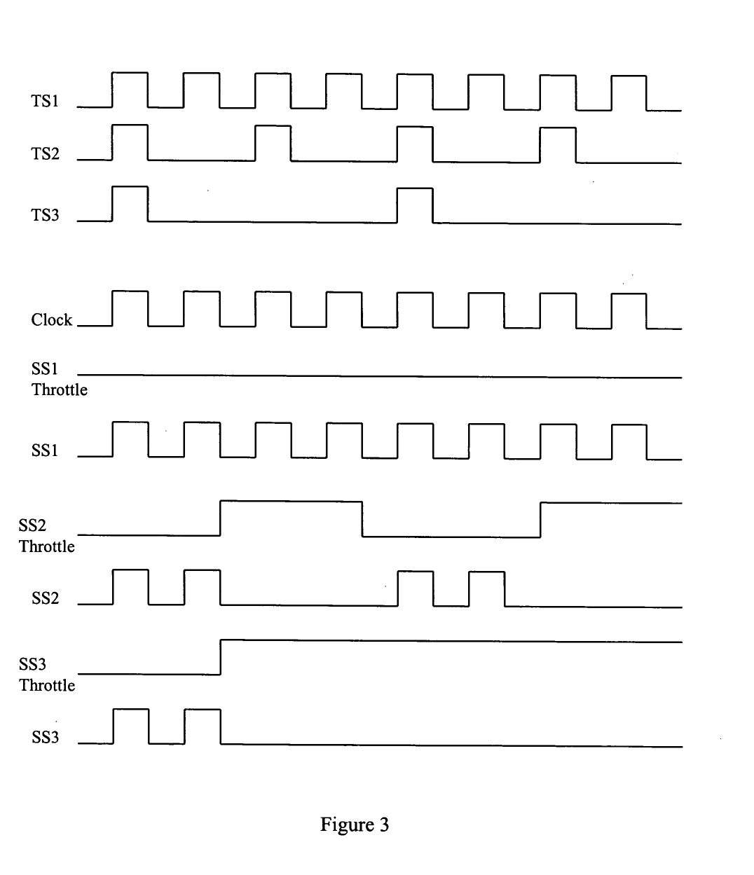

FIG. 3 illustrates various signals associated with simulating a processor performance state. The TS1 signal represents a clock frequency associated with a first true processor performance state. In the time interval illustrated, eight leading clock edges are presented. This TS1 signal may correspond to a high frequency processor performance state. The TS2 signal represents a clock frequency associated with a second true processor performance state. In the time interval illustrated, four leading clock edges are presented. This TS2 signal may correspond to a lower frequency state. The TS3 signal represents a clock frequency associated with a third true processor performance state. In the time interval illustrated, two leading clock edges are presented. The TS3 signal may correspond to a low frequency state. In the true processor performance states associated with TS1, TS2, and TS3, the internal clock frequency of a processor has been changed. Similarly, a voltage level associated with the processor may also be changed.

The signals SS1, SS2, and SS3 represent simulated processor performance states that correspond to true processor performance states TS1, TS2, and TS3. To produce the simulated processor performance states, a clock signal available to a clock may be blocked for periods of time by a throttling signal. For example, a STOPCLK signal may be asserted on a STOPCLK# line available to the processor. The signal SS1 Throttle is illustrated remaining in a deasserted state throughout the illustrated interval. Thus, the signal SS1 matches the clock signal. Similarly, the signal SS1 matches the TS1 signal with eight leading clock edges presented. Therefore, signal SS1 simulates at least the frequency portion of a true processor performance state associated with TS1.

The signal SS2 results from the interaction of the SS2 Throttle signal and the Clock signal. The SS2 Throttle signal is asserted for two periods of time and deasserted for two periods of time. When asserted, the Clock signal is blocked (e.g., via a logical AND operation) and the SS2 signal represents the clocking that would occur in a processor. The signal SS2 presents four leading clock edges during the time interval illustrated. However, the four leading clock edges in SS2 are not presented with the same constant frequency like the four leading clock edges in TS2. Thus, while the same number of leading clock edges are presented in the time interval, which yields a similar effective frequency, the actual internal frequency of the processor has not been changed. Therefore, rather than an actual processor performance state being generated, as represented by TS2, a simulated processor performance state corresponding to the true state represented by TS2 is produced by SS2.

The signal SS3 results from the interaction of the SS3 Throttle signal and the Clock signal. The SS3 Throttle signal is asserted for one period of time and deasserted for one period of time. When asserted, the Clock signal is blocked and the SS3 signal represents that clocking that would occur in a processor. The signal SS3 presents two leading clock edges during the time interval illustrated. However, the two leading clock edges in SS3 are not presented with the constant frequency of the two leading clock edges in TS3. Thus, while the same number of leading clock edges are presented in the time interval, which yields a similar effective frequency, the actual internal frequency of the processor has not been changed. Therefore, rather than an actual processor performance state being generated, as represented by TS3, a simulated processor performance state that corresponds to the actual processor performance state represented by TS3 is produced by SS3.

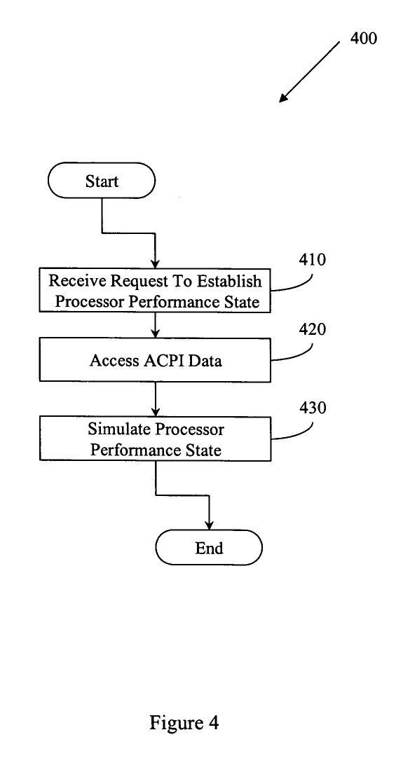

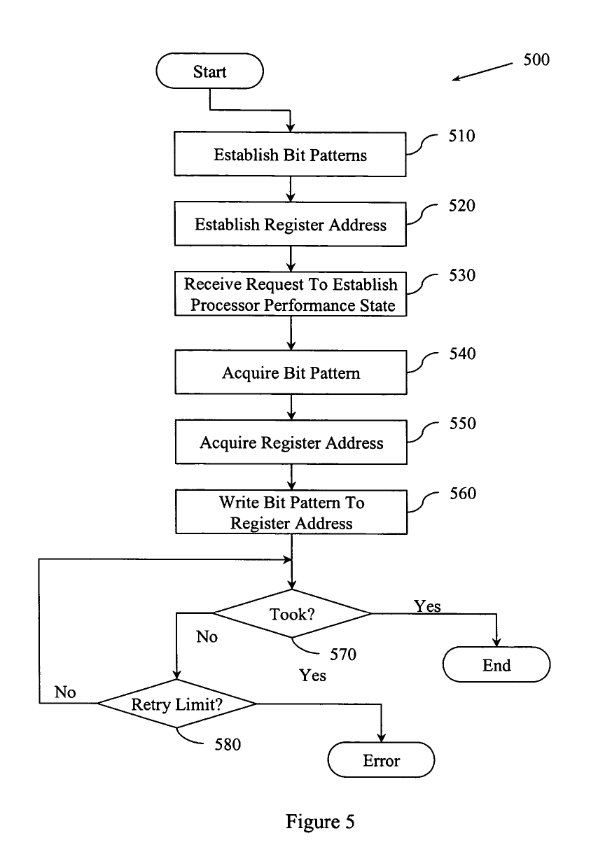

Example methods may be better appreciated with reference to the flow diagrams of FIGS. 4 and 5. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 4 illustrates an example method 400 for simulating a processor performance state. The method 400 may include, at 410, receiving a request to establish a processor performance state in a processor. The request may come, for example, from an operating system and/or an application that desires to have the processor change to a desired processor performance state. The request may be generated in response to an action (e.g., choice made from a graphical user interface), to a state (e.g., thermal condition), in response to an analysis (e.g., predicted CPU utilization), and the like. By way of illustration, an operating system may determine that a first application like a manual data entry application may only require a minimal amount of CPU time and thus may request a lower processor performance state. By way of further illustration, the operating system may subsequently determine that a second application like a real-time three-dimensional rendering program may require a greater amount of CPU time and thus may request a higher processor performance state.

The method 400 may then proceed, at 420, to access a data structure. The data structure may be accessed to acquire a bit pattern to write to an ACPI throttling register, an address for the ACPI throttling register, and the like. Thus, rather than the method driving an internal clock frequency for a processor and changing an internal operating voltage for a processor, as might be anticipated by the operating system, a different set of actions may occur. The operating system may remain unaware that a different set of actions is occurring and thus the fact that a simulated processor performance state is produced rather than a true processor performance state may be transparent to the operating system.

The method 400 may then proceed, at 430, to simulate a processor performance state by causing the processor to be throttled in response to writing the bit pattern to the ACPI throttling register. Thus, various clock patterns, like those illustrated in FIG. 3, may be produced to simulate a processor performance state.

In one example, the method 400 may facilitate simulating processor performance states that correspond to a higher performance state and a lower performance state. In another example, the method 400 may facilitate simulating four or eight processor performance states. In yet another example, the method 400 may facilitate simulating a user-defined set of processor performance states. Thus, a number of desired performance states may be simulated (e.g., 2, 3, 4, 7, 13, 25). In one example, eight processor performance states may be implemented by throttling the processor 0%, 12.5%, 25%, 37.5%, 50%, 62.5%, 75%, and 87.5% of the time. While three different sets of simulated states are described, it is to be appreciated that a greater and/or lesser number of states may be simulated. Furthermore, while 0%, 12.5%, 25% and so on are described, it is to be appreciated that other throttling percentages may be employed.

While FIG. 4 illustrates various actions occurring in serial, it is to be appreciated that various actions illustrated in FIG. 4 could occur substantially in parallel. By way of illustration, a first process could receive requests to establish processor performance states. Similarly, a second process could access ACPI data like bit patterns to write to a throttling register and the address of that throttling register, while a third process could facilitate simulating the desired processor performance state by writing a retrieved bit pattern to a retrieved register address. While three processes are described, it is to be appreciated that a greater and/or lesser number of processes could be employed and that lightweight processes, regular processes, threads, and other approaches could be employed.

FIG. 5 illustrates an example method 500 for simulating a processor performance state. The method 500 includes, at 510, establishing a bit pattern(s) in a data structure. The data structure may be accessed to retrieve a bit pattern to write to an ACPI throttling register. In one example, the bit patterns may be burnt into the data structure when a system is manufactured while in another example the bit patterns may be user-configurable via, for example, a graphical user interface. The bit patterns may be established in a data structure that is stored as an ACPI table in a Basic Input Output System (BIOS) operably connectable to the processor.

The method 500 may also include, at 520, establishing a register address(es) in the data structure. The register address may be the address of an ACPI throttling register to which a bit pattern can be written to facilitate throttling a processor to produce a simulated processor performance state. Additionally, the register address may be the address of a status register from which a throttling status can be read. Thus, in one example, the method 500 may include establishing a data structure by writing a set of bit patterns to an ACPI table and writing the address of an ACPI throttling register to the ACPI table.

The method 500 may also include, at 530, receiving a request to establish a processor performance state. The request may come from an operating system, an application, a user, and so on. Instead of driving an internal processor frequency and an internal processor voltage by writing internal machine specific registers, the method 500 may instead, at 540 acquire a bit pattern that can be written to an ACPI throttling register to throttle a processor. Since ACPI data structures and methods may virtualize a hardware environment, the method 500 may also include, at 550, acquiring an address of the ACPI throttling register to which the bit pattern acquired at 540 can be written. After acquiring the bit pattern and the throttling register address, the method 500 may, at 560, write the bit pattern to the throttling register. In one example, writing the bit pattern to the ACPI throttling register causes a signal to be asserted on a STOPCLK# line into the processor.

The method 500 may also include, at 570, making a determination concerning whether writing the bit pattern to the throttling register caused the desired throttling action—did the write take? The determination may be made, for example, by reading a status register. Thus, the method 500 may include, acquiring an address of an ACPI status register configured to report a value related to a throttling status of the processor, reading the value from the status register, and selectively reporting a success or error condition based on the value. If the determination at 570 is Yes, then the method 500 may conclude. In another example, the method 500 may return to 530 and wait for another request to simulate another processor performance state. But if the determination at 570 is No, then another determination may be made at 580 concerning whether a retry limit of status checks has occurred. If the retry limit has been exceeded, an error condition may be reported, otherwise the method 500 may return to 570 for another status check.

While FIG. 5 illustrates various actions occurring in serial, it is to be appreciated that various actions illustrated in FIG. 5 could occur substantially in parallel. By way of illustration, a first process could establish bit patterns and register addresses, a second process could receive requests to establish processor performance states, a third process could acquire bit patterns and register addresses, a fourth process could write bit patterns to registers, and a fifth process could determine whether the desired processor performance state has been emulated. While five processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method for simulating a processor performance state in a processor. The method may include establishing an ACPI table in a Basic Input Output System (BIOS) operably connectable to the processor, where establishing the ACPI table includes writing a set of bit patterns to the ACPI table, and writing an address of an ACPI throttling register to the ACPI table. The method may also include receiving a request to establish a processor performance state in the processor, where the processor performance state corresponds to a higher frequency state or a lower frequency state. The method may also include accessing the ACPI table to acquire a bit pattern to write to the ACPI throttling register and an address for the ACPI throttling register. Ultimately the method may conclude by causing a processor to simulate a processor performance state by throttling the processor by writing the bit pattern to the ACPI throttling register. While the above method is described being stored on a computer-readable medium, it is to be appreciated that other example methods described herein can also be stored on a computer-readable medium.

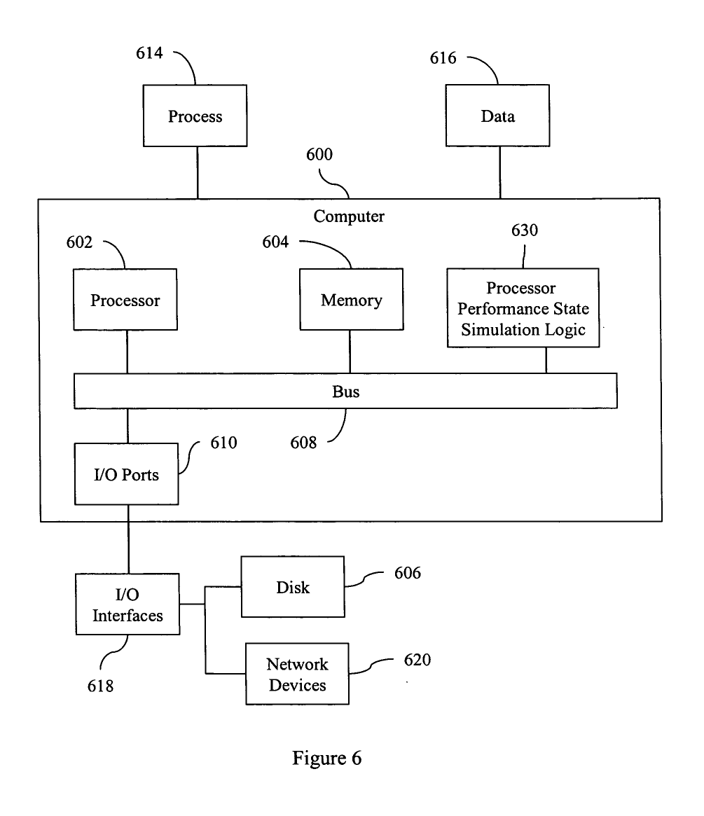

FIG. 6 illustrates a computer 600 that includes a processor 602, a memory 604, and input/output ports 610 operably connected by a bus 608. While a single bus 608 is illustrated, it is to be appreciated that various components may be connected by other busses. In one example, the computer 600 may include a processor performance state simulation logic 630 configured to facilitate simulating processor performance states in processor 602. While a true processor performance state might include changing the operating frequency of processor 602 and/or the operating voltage of processor 602, simulating a processor performance state using processor performance state simulation logic 630 using the example systems and methods described herein may include throttling a clock signal to the processor 602. For example, a STOPCLK# line may run from bus 608 to processor 602. By asserting a STOPCLK signal on the STOPCLK# line, the processor 602 may be throttled, thereby simulating a processor performance state.

The processor 602 can be a variety of various processors including dual microprocessor and other multi-processor architectures. The memory 604 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 can include, but is not limited to, devices like a magnetic disk drive, a solid state disk drive, a floppy disk drive, a tape drive, a Zip drive, a flash memory card, and/or a memory stick. Furthermore, the disk 606 can include optical drives like a CD-ROM, a CD recordable drive (CD-R drive), a CD rewriteable drive (CD-RW drive), and/or a digital video ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus or mesh architectures. While a single bus is illustrated, it is to be appreciated that computer 600 may be internally connected via and/or communicate with various devices, logics, and peripherals using other busses that are not illustrated (e.g., PCIE, SATA, Infiniband, 1394, USB, Ethernet). The bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and the like. The input/output ports 610 can include but are not limited to, serial ports, parallel ports, and USB ports.

The computer 600 can operate in a network environment and thus may be connected to network devices 620 via the i/o devices 618, and/or the i/o ports 610. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network devices 620 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 620 can connect to WAN technologies including, but not limited to, point to point links, circuit switching networks like integrated services digital networks (ISDN), packet switching networks, and digital subscriber lines (DSL).

In one example, computer 600 may be configured with a system for simulating a processor performance state. The system may include a data structure stored in a memory. The data structure may store the address of an ACPI throttling register and a set of bit patterns that may be written to the ACPI throttling register. The system may also include a logic configured to receive a request to establish a desired processor performance state in a processor. The logic may facilitate establishing the desired processor performance state by selecting a bit pattern from the set of bit patterns to be written to the ACPI throttling register, and causing the processor to be throttled in a manner that simulates the desired processor performance state by writing the selected bit pattern to the ACPI throttling register.

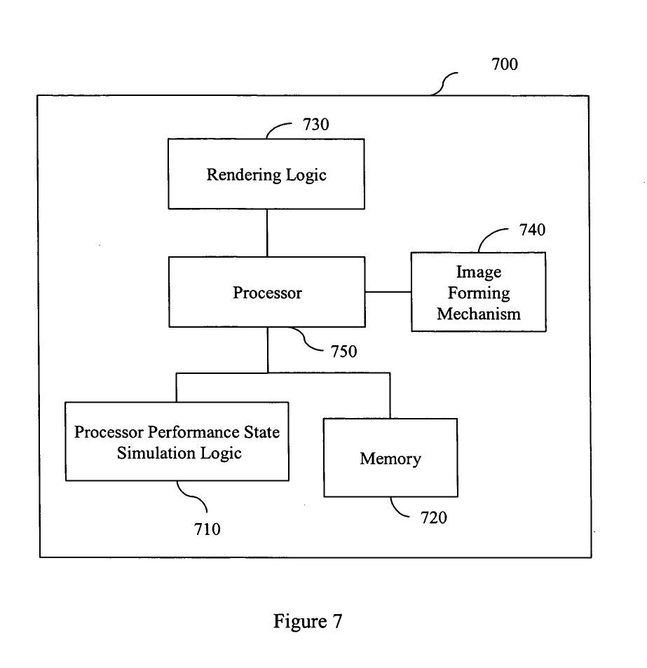

FIG. 7 illustrates an example image forming device 700 that includes a processor performance state simulation logic 710 similar to the example systems described herein. The processor performance state simulation logic 710 may include a logic that is configured to perform the executable methods like those described herein. The processor performance state simulation logic 710 may be permanently and/or removably attached to the image forming device 700. While processor performance states may be more typically associated with computers (e.g., laptops), sophisticated printers that include processors like processor 750 may similarly be concerned with adaptive power management, heat dissipation, and the like. Thus, processor performance state simulation logic 710 may simulate processor performance states for processor 750 by, for example, throttling a clock signal supplied to processor 750.

The image forming device 700 may receive print data to be rendered. Thus, image forming device 700 may also include a memory 720 configured to store print data or to be used more generally for image processing. The image forming device 700 may also include a rendering logic 730 configured to generate a printer-ready image from print data. Rendering varies based on the format of the data involved and the type of imaging device. In general, the rendering logic 730 converts high-level data into a graphical image for display or printing (e.g., the print-ready image). For example, one form is ray-tracing that takes a mathematical model of a three-dimensional object or scene and converts it into a bitmap image. Another example is the process of converting HTML into an image for display/printing. It is to be appreciated that the image forming device 700 may receive printer-ready data that does not need to be rendered and thus the rendering logic 730 may not appear in some image forming devices.

The image forming device 700 may also include an image forming mechanism 740 configured to generate an image onto print media from the print-ready image. The image forming mechanism 740 may vary based on the type of the imaging device 700 and may include a laser imaging mechanism, other toner-based imaging mechanisms, an ink jet mechanism, digital imaging mechanism, or other imaging reproduction engine. A processor 750 may be included that is implemented with logic to control the operation of the image-forming device 700. In one example, the processor 750 includes logic that is capable of executing Java instructions. Other components of the image forming device 700 are not described herein but may include media handling and storage mechanisms, sensors, controllers, and other components involved in the imaging process.

In one example, the printer 700 may be configured with a system for simulating a processor performance state. The system may include a data structure stored in a memory. The data structure may store the address of an ACPI throttling register and a set of bit patterns that may be written to the ACPI throttling register. The system may also include a logic configured to receive a request to establish a desired processor performance state in a processor. The logic may facilitate establishing the desired processor performance state by selecting a bit pattern from the set of bit patterns to be written to the ACPI throttling register, and causing the processor to be throttled in a manner that simulates the desired processor performance state by writing the selected bit pattern to the ACPI throttling register.

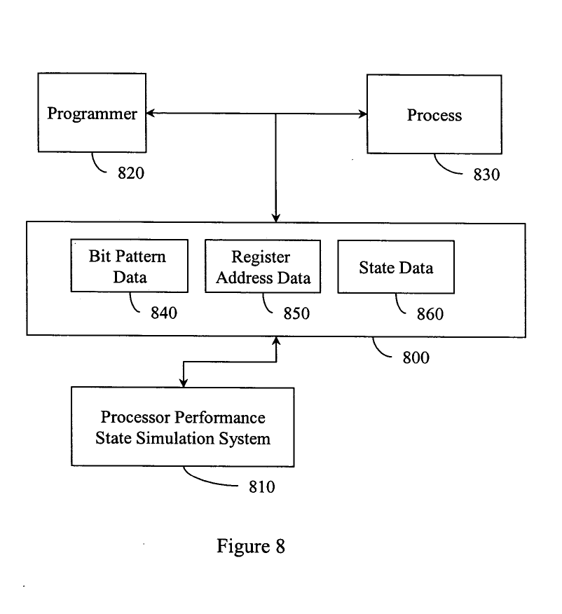

Referring now to FIG. 8, an application programming interface (API) 800 is illustrated providing access to a system 810 for simulating processor performance states. The API 800 can be employed, for example, by a programmer 820 and/or a process 830 to gain access to processing performed by the system 810. For example, a programmer 820 can write a program to access the system 810 (e.g., invoke its operation, monitor its operation, control its operation) where writing the program is facilitated by the presence of the API 800. Rather than programmer 820 having to understand the internals of the system 810, the programmer 820 merely has to learn the interface to the system 810. This facilitates encapsulating the functionality of the system 810 while exposing that functionality.

Similarly, the API 800 can be employed to provide data values to the system 810 and/or retrieve data values from the system 810. For example, a process 830 that processes bit patterns that facilitate controlling an ACPI throttling register can provide bit patterns to the system 810 via the API 800 by, for example, using a call provided in the API 800. Thus, in one example of the API 800, a set of application programming interfaces can be stored on a computer-readable medium. The interfaces can be employed by a programmer, computer component, logic, and so on to gain access to a system 800 for simulating processor performance states. The interfaces can include, but are not limited to, a first interface 840 that communicates a bit pattern data, a second interface 850 that communicates a register address data, and a third interface 860 that communicates a state data retrieved from a status register after a bit pattern data communicated via bit pattern interface 840 has been applied to an ACPI throttling register identified by register address data communicated through register address data interface 850.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Gamer, A Dictionary of Modem Legal Usage 624 (2d. Ed. 1995).

1. A system for simulating a processor performance state, comprising:
a data structure stored in a memory, the data structure being configured to store an address of an ACPI throttling register, and a set of bit patterns that may be written to the ACPI throttling register, and
a logic configured to receive a request to establish a desired processor performance state in a processor, to select a bit pattern from the set of bit patterns to be written to the ACPI throttling register, and to cause the processor to be throttled in a manner that simulates the desired processor performance state by writing the selected bit pattern to the ACPI throttling register.

2. The system of claim 1, where the data structure is further configured to store an address of an ACPI status register from which a value related to a throttling status established by the ACPI throttling register can be read.

3. The system of claim 1, where the memory is operably connectable to a Basic Input Output System (BIOS) configured to facilitate controlling one or more processor functions.

4. The system of claim 1, where the data structure comprises an ACPI table stored in a memory that is operably connectable to a Basic Input Output System (BIOS) configured to facilitate controlling one or more processor functions.

5. The system of claim 1, where the data structure comprises an ACPI table stored in a Basic Input Output System (BIOS) configured to facilitate controlling one or more processor functions.

6. The system of claim 1, where the set of bit patterns facilitates simulating two processor performance states that correspond to a higher performance state and a lower performance state.

7. The system of claim 1, where the set of bit patterns facilitates simulating four processor performance states.

8. The system of claim 1, where the set of bit patterns facilitates simulating two or more processor performance states.

9. The system of claim 8, where the two or more processor performance states include eight processor performance states simulated by throttling the processor 0%, 12.5%, 25%, 37.5%, 50%, 62.5%, 75%, and 87.5% of the time.

10. The system of claim 1, where the ACPI throttling register is configured to cause the processor to be throttled by asserting a signal on a line connected to the processor.

11. The system of claim 10, where the line comprises the STOPCLK# line.

12. A computer configured with a system for simulating a processor performance state, the system comprising:
a data structure stored in a memory, the data structure being configured to store an address of an ACPI throttling register and a set of bit patterns that may be written to the ACPI throttling register, and
a logic configured to receive a request to establish a desired processor performance state in a processor, to select a bit pattern from the set of bit patterns to be written to the ACPI throttling register, and to cause the processor to be throttled in a manner that simulates the desired processor performance state by writing the selected bit pattern to the ACPI throttling register.

13. A printer configured with a system for simulating a processor performance state, the system comprising:
a data structure stored in a memory, the data structure being configured to store an address of an ACPI throttling register and a set of bit patterns that may be written to the ACPI throttling register, and
a logic configured to receive a request to establish a desired processor performance state in a processor, to select a bit pattern from the set of bit patterns to be written to the ACPI throttling register, and to cause the processor to be throttled in a manner that simulates the desired processor performance state by writing the selected bit pattern to the ACPI throttling register.

14. A method for simulating a processor performance state, comprising:
receiving a request to establish a processor performance state in a processor;
accessing a data structure to acquire a bit pattern to write to an ACPI throttling register and an address for the ACPI throttling register; and
simulating a processor performance state by causing the processor to be throttled in response to writing the bit pattern to the ACPI throttling register.

15. The method of claim 14, including establishing the data structure as an ACPI table in a Basic Input Output System (BIOS) operably connectable to the processor.

16. The method of claim 15, where establishing the data structure includes writing a set of bit patterns to the ACPI table and writing the address of the ACPI throttling register to the ACPI table.

17. The method of claim 14, where the processor performance state corresponds to one of a higher performance state and a lower performance state.

18. The method of claim 14, where the processor performance state corresponds to one of two or more user defined processor performance states.

19. The method of claim 14, where the processor performance state corresponds to one of eight processor performance states including a state where the processor is throttled one of 0%, 12.5%, 25%, 37.5%, 50%, 62.5%, 75%, and 87.5% ofthe time.

20. The method of claim 14, where writing the bit pattern to the ACPI throttling register causes a signal to be asserted on a STOPCLK# line into the processor.

21. The method of claim 14, including:
acquiring an address of an ACPI status register configured to report a value related to a throttling status of the processor;
reading the value from the ACPI status register; and
selectively reporting a success or error condition based on the value.

22. A computer-readable medium storing processor executable instructions operable to perform a method for simulating a processor performance state in a processor, the method comprising:
establishing an ACPI table in a Basic Input Output System (BIOS) operably connectable to the processor, where establishing the ACPI table includes writing a set of bit patterns to the ACPI table, and writing an address of an ACPI throttling register to the ACPI table;
receiving a request to establish a processor performance state in the processor, where the processor performance state corresponds to one of a higher frequency state and a lower frequency state;
accessing the ACPI table to acquire a bit pattern to write to the ACPI throttling register and an address for the ACPI throttling register; and
causing a processor to simulate a processor performance state by throttling the processor by writing the bit pattern to the ACPI throttling register.

23. A system, comprising:
means for accessing ACPI data;
means for receiving a request to drive a processor into a processor performance state; and
means for controlling a clock signal to the processor by writing data retrieved from the ACPI data to an ACPI throttling register, where controlling the clock signal simulates the processor performance state.

24. A set of application programming interfaces embodied on a computer-readable medium for execution by a computer component in conjunction with simulating a processor performance state in a processor by controlling an ACPI throttling register, comprising:
a first interface for communicating a bit pattern data;
a second interface for communicating an ACPI throttling register address data; and
a third interface for communicating a state data, where the state data is related to a simulated processor performance state generated by applying the bit pattern data to a register identified by the register address data.
